(19) United States
(12) Patent Application Publication
(10) Pub. No.: US 2007/0269258 A1
(43) Pub. Date: Nov. 22, 2007

(54) Angled permanent marker

(76) Inventor: Steven Bowers, Concord, NC (US)

Correspondence Address: Raymond M. Galasso;Galasso & Associates LP, P.O. Box 26503, Austin, TX, 78755-0503, US

(21) Appl. No.: 11/800,025

(22) Filed: May 3, 2007

Related U.S. Application Data
(60) Provisional application No. 60/797,894, filed on May 5, 2006.

(51) Int. Cl. B43K 8/06

(52) U.S. Cl. 401/198

(57) ABSTRACT

Angled Permanent Marker is a marker having a thin, angled tip. The preferred embodiment of the invention utilizes a marker housing with an ink reservoir in the interior, ink within the ink reservoir, an angled felt tip connected to the ink reservoir and located inside and emanating from a felt tip cover, and a protective cap with a pocket clip. To use the preferred embodiment of Angled Permanent Marker, an individual would begin his art or construction project in the ordinary manner. When he encounters an area that is difficult to reach or inaccessible to an ordinary marker or pen, he would remove the protective cap, revealing the angled felt tip. The housing could then be held parallel to the item to be marked or at any other orientation to allow the previously inaccessible region to be marked by the angled felt tip. When the user completes the project, the protective cap would be placed over the angled felt tip to prevent it from drying out or being damaged between uses.

### CROSS REFERENCE TO RELATED APPLICATIONS

This United States Non-Provisional patent Application claims priority to U.S. Provisional Patent Application No. 60/797,894 entitled “Angled Permanent Marker” filed on May 5, 2006.

### FIELD OF THE DISCLOSURE

The disclosures made herein relate generally to the art, hobby and construction accessories industries. The invention discussed herein is in the general classification of alternatively designed markers.

### BACKGROUND

During construction projects, the need to mark certain areas of a device or material often arises. Unfortunately, many of these areas can be difficult to reach or inaccessible to traditional pens and markers.

Art projects also often require an individual to access areas that are narrow or covered and, consequently, difficult to reach. This is particularly true for people who enjoy hobbies such as woodworking or model building.

Currently, those in need of marking or coloring difficult to reach locations must attempt to jam a standard marker into the area or cut the tip of the marker or pen to attempt to reach the desired location. This process is often messy, imprecise and time consuming. It also does not work at all on many occasions.

Hence, there is a need in the art for a convenient to use, inexpensive, durable, safe and effective device for reaching and marking otherwise difficult to reach or inaccessible locations.

### SUMMARY OF THE DISCLOSURE

Angled Permanent Marker is a marker having a thin, angled tip.

The preferred embodiment of the invention utilizes a marker housing with an ink reservoir in the interior, ink within the ink reservoir, an angled felt tip connected to the ink reservoir and located inside and emanating from a felt tip cover, and a protective cap with a pocket clip.

The principal object of this invention is to provide a device that can be used to mark or otherwise color difficult to reach or inaccessible locations.

Another object of this invention is to provide a device that is suitable for construction applications.

Another object of this invention is to provide a device that is suitable for artwork applications.

Another object of this invention is to provide an affordable device for marking difficult to reach or inaccessible locations.

Another object of this invention is to provide an easily used device for marking difficult to reach or inaccessible locations.

Another object of this invention is to provide a reliable device for marking difficult to reach or inaccessible locations.

Yet another object of this invention is to provide a durable device for marking difficult to reach or inaccessible locations.

### BRIEF DESCRIPTION OF THE DRAWINGS

FIG. 1 depicts a perspective view of the preferred embodiment of the present invention.

FIG. 2 depicts a cross-sectional view of the front end of the preferred embodiment of the present invention.

### DETAILED DESCRIPTION OF THE DRAWINGS

The preferred embodiment of Angled Permanent Marker is comprised of at least some of the following: a marker housing with an ink reservoir in the interior, ink within the ink reservoir, an angled felt tip connected to the ink reservoir and located inside and emanating from a felt tip cover, and a protective cap with a pocket clip.

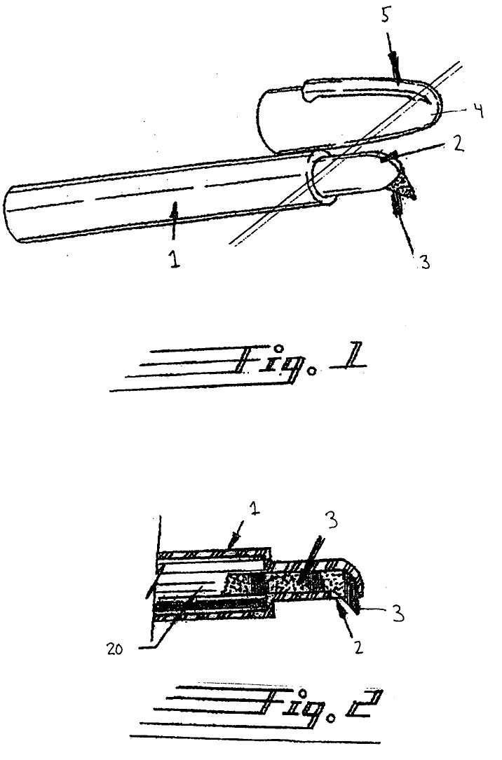

FIG. 1 depicts a perspective view of the preferred embodiment of the present invention. A housing 1 creates an ink reservoir (not pictured) in the interior. The housing 1 is approximately cylindrical and made of plastic in this preferred embodiment though the exact shape and material is not critical to the invention. The housing 1 has an outer diameter ranging from three-quarters of an inch to one inch in the preferred embodiment although almost any size could be utilized. The housing 1 is four and a half inches in length in this preferred embodiment, although again, any of a variety of lengths would be appropriate.

Indelible ink (not pictured) is located inside the ink reservoir of the preferred embodiment shown. The indelible ink is pre-filled into the ink reservoir and comes in a variety of colors such as red, green, blue brown, purple and black.

A felt tip cover 2 that is also approximately cylindrical and made of plastic in this preferred embodiment emanates from the housing 1. The felt tip cover 2 is of a smaller diameter than the housing 1 in this preferred embodiment. The felt tip cover 2 is one inch in length in this preferred embodiment although the exact length is not critical to the invention. The felt tip cover 2 curves at one end to permit an angled felt tip 3 to protrude at an angle.

The angled felt tip 3 extends into the ink reservoir within the housing 1 and is located inside and emanates from the felt tip cover 2. The angled felt tip 3 curves and then angles seventy-five to eighty degrees from the felt tip cover 2. The angled felt tip 3 is thin and pointed to allow it to access a variety of locations. The angled felt tip 3 could be a variety of sizes. In the preferred embodiment, the angled felt tip is a millimeter or two thick and extends one or two centimeters from the felt tip cover 2.

A protective cap 4 is dimensioned to fit over the angled felt tip 3. The protective cap 4 is also approximately cylindrical and made of plastic. The protective cap 4 has a large enough diameter to extend over the felt tip cover 2 and the angled felt tip 3. The protective cap 4 protects the angled felt tip 3 from damage when it is not in use and prevents the angled felt tip 3 from drying out during periods of non-use. The preferred embodiment of the protective cap 4 also has pocket clip 5 as typical with many pens and markers. The pocket clip 5 allows a user to attach the housing 1 and protective cap 4 to an edge of a notebook or a pocket, if desired. The pocket clip 5 could be made of metal or plastic in the preferred embodiment.

FIG. 2 depicts a cross-sectional view of the front end of the preferred embodiment of the present invention. The housing 1 is shown surrounding the ink reservoir 20 containing the indelible ink. The angled felt tip 3 extends into the ink reservoir 20 and is surrounded by the felt tip cover 2. The angled felt tip 3 protrudes from the end of the felt tip cover 2.

To use the preferred embodiment of Angled Permanent Marker, an individual would begin his art or construction project in the ordinary manner. When he encounters an area that is difficult to reach or inaccessible to an ordinary marker or pen, he would remove the protective cap, revealing the angled felt tip. The housing could then be held parallel to the item to be marked or at any other orientation to allow the previously inaccessible region to be marked by the angled felt tip. When the user completes the project, the protective cap would be placed over the angled felt tip to prevent it from drying out or being damaged between uses.

The materials utilized for Angled Permanent Marker may vary widely but will likely include metal and plastic components. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Angled Permanent Marker can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

It should be obvious that the components of the present invention can be of various shapes and sizes. It should also be obvious that the components of the invention can be made of different types of plastics or other suitable materials and can be of any color. Although the disclosure herein is referenced as a marker, it could be any of a variety of pens or other marking devices utilizing ink or the like.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A marking device comprising:
(a) a housing;
(b) an ink reservoir within the housing; and
(c) an angled felt tip connected to the ink reservoir and located partially within and emanating from the housing.

2. The device of claim 1 wherein the housing is approximately cylindrical.

3. The device of claim 1 wherein the housing is made of plastic.

4. The device of claim 2 wherein the housing has a diameter ranging from three-quarters of an inch to one inch.

5. The device of claim 1 wherein the housing is four and a half inches in length.

6. The device of claim 1 further comprising
an ink located in the ink reservoir.

7. The device of claim 6 wherein the ink is indelible.

8. The device of claim 1 further comprising
a felt tip cover surrounding the angled felt tip and emanating from the housing.

9. The device of claim 8 wherein the felt tip cover is approximately cylindrical.

10. The device of claim 8 wherein the felt tip cover is made of plastic.

11. The device of claim 9 wherein the felt tip cover is of a smaller diameter than the housing.

12. The device of claim 8 wherein the angled felt tip curves and then angles seventy-five to eighty degrees from the bottom of the felt tip cover.

13. The device of claim 1 wherein the angled felt tip is thin and pointed at the end.

14. The device of claim 8 wherein the angled felt tip is a millimeter thick and extends one centimeter from the felt tip cover.

15. The device of claim 1 further comprising
a protective cap dimensioned to fit over the angled felt tip.

16. The device of claim 15 wherein the protective cap is approximately cylindrical and made of plastic.

17. The device of claim 15 further comprising
a pocket clip attached to the protective cap.

18. A marking device comprising:
(a) a housing;
(b) an ink reservoir containing an indelible ink within the housing;
(c) a felt tip cover emanating from the housing;
(d) an angled felt tip located within the felt tip cover and connected to the ink reservoir within the housing and that is thin and pointed at the end and angles seventy-five to eighty degrees and emanates from the felt tip cover;
(e) a protective cap dimensioned to fit over the angled felt tip and the felt tip cover; and
(f) a pocket clip attached to the protective cap.
